(19) United States
(12) Patent Application Publication
(10) Pub. No.: US 2023/0393013 A1
(43) Pub. Date: Dec. 7, 2023

(54) METHODS AND APPARATUS FOR MEASURING METHANE EMISSIONS WITHIN A MESH SENSOR NETWORK

(71) Applicant: SeekOps Inc., Austin, TX (US)

(72) Inventors: Ian Michael Cooper, Canyon Lake, TX (US); James Rutherford, Cypress, TX (US); Brendan James Smith, Lakeway, TX (US)

(21) Appl. No.: 18/033,936

(22) PCT Filed: Oct. 26, 2021
(86) PCT No.: PCT/US21/56708

§ 371 Date: Apr. 26, 2023

Related U.S. Application Data
(60) Provisional application No. 63/106,179, filed on Oct. 27, 2020.

(51) Int. Cl. G01M 3/04; G01W 1/06

(52) U.S. Cl. CPC G01M 3/04; G01W 1/06; G01W 2001/006

(57) ABSTRACT

Systems, devices, and methods for a sensor pair, where the sensor pair comprises: an emissions sensor configured to generate trace gas data; a wind sensor configured to generate wind data, where the wind data comprises wind speed and wind direction; and a position data, where the position data comprises a location corresponding to the generated trace gas data and generated wind data.

### CROSS-REFERENCE TO RELATED APPLICATION

This application is a 35 U.S.C § 371 National Stage Entry of International Application No. PCT/US21/56708, filed Oct. 26, 2021, which claims the priority benefit of U.S. Provisional Patent Application Ser. No. 63/106,179 filed Oct. 27, 2020, incorporated herein by reference in its entirety.

### FIELD OF ENDEAVOR

The invention relates to greenhouse gas emissions, and more particularly to the detection and quantification of greenhouse gasses.

### BACKGROUND

Methane (CH4) is an odorless and colorless naturally occurring organic molecule, which is present in the atmosphere at average ambient levels of approximately 1.85 ppm as of 2018 and is projected to continually climb. Methane is a powerful greenhouse gas, a source of energy (i.e., methane is flammable), and an explosion hazard, and so detection of methane is of utility to scientists as well as engineers. While methane is found globally in the atmosphere, a significant amount is collected or “produced” through anthropogenic processes including exploration, extraction, and distribution of petroleum resources as a component in natural gas. Natural gas, an odorless and colorless gas, is a primary fuel used to produce electricity and heat. The main component of natural gas is typically methane, and the concentration of methane in a stream of natural gas can range from about 70% to 90%. The balance of the gas mixture in natural gas consists of longer chain hydrocarbons, including ethane, propane, and butane, typically found in diminishing mole fractions that depend on the geology of the earth from which the gas is extracted. Once extracted from the ground, natural gas is processed into a product that must comply with specifications for both transport, taxation, and end-use in burners; specification of processed ‘downstream’ natural gas product control for the composition of the gas, so as to protect transport lines from corrosion and ensure proper operation of burners and turbines. While extraction of natural gas is one of the main sources of methane in the atmosphere, major contributors of methane also include livestock farming (i.e., enteric fermentation) and solid waste and wastewater treatment (i.e., anaerobic digestion). Anaerobic digestion and enteric fermentation gas products consist primarily of methane and lack additional hydrocarbon species. Additionally, the methane produced by formal anaerobic digestion processes, known as ‘biogas’, can be used at the farm for heat, power or other fuel applications, or can be upgraded on site to biomethane, where it can be put into the pipeline/gas grid.

### SUMMARY

A system embodiment may include: a sensor pair, where the sensor pair comprises: an emissions sensor configured to generate trace gas data; a wind sensor configured to generate wind data, where the wind data comprises wind speed and wind direction; and a position data, where the position data comprises a location corresponding to the generated trace gas data and generated wind data.

Additional system embodiments may include: at least one LED, where the at least one LED is configured to illuminate based on a severity of a gas leak within a proximity to the sensor pair based on the generated trace gas data and generated wind data. In additional system embodiments, the severity of the gas leak is based on a predetermined threshold. In additional system embodiments, the severity of the gas leak is based on an adaptive threshold.

Additional system embodiments may include: a processor having addressable memory, where the processor is configured to: determine a risk profile for one or more equipment, where the one or more equipment have a potential to leak trace gas. In additional system embodiments, the determined risk profile is based on at least one of: a history of specific equipment leak risk, a time since a last leak, a history of actual leaks, a time since last maintenance, and a time since last repair.

In additional system embodiments, the processor is further configured to: move the sensor pair relative to the one or more equipment based on the determined risk profile. In additional system embodiments, the sensor pair is moved to a location having a higher risk of a leak. In additional system embodiments, the sensor pair is moved to a location not adequately represented. Additional system embodiments may include: one or more rails, where the sensor pair is moved along the one or more rails to a new location.

A method embodiment may include: determining a risk profile for one or more trace gas equipment with a potential to leak trace gas; moving one or more sensor pairs relative to the one or more trace gas equipment based on the determined risk profile; and generating trace gas data from the moved one or more sensor pairs.

In additional method embodiments, the determined risk profile is based on at least one of: a history of equipment leak risk, a time since a last leak, a history of actual leaks, a time since last maintenance, and a time since last repair. In additional method embodiments, the trace gas data is generated from an emissions sensor of the one or more sensor pairs.

Additional method embodiments may include: generating wind data from a wind sensor of the one or more sensor pairs. In additional method embodiments, the generated wind data comprises wind speed and wind direction.

Another method embodiment may include: generating a first trace gas data from an emissions sensor of a sensor pair; generating a first wind data from the sensor pair; determining a first location corresponding to the generated first trace gas data and first wind data; moving the sensor pair to a second location based on a determined risk profile; generating a second trace gas data from the emissions sensor of the sensor pair; generating a second wind data from the sensor pair; and determining a second location corresponding to the generated second trace gas data and second wind data.

In additional method embodiments, the sensor pair comprises a gas sensor and a wind sensor. In additional method embodiments, the first wind data includes the wind speed and the wind direction, and the second wind data includes the wind speed and wind direction. In additional method embodiments, a GPS determines the first location and the second location. In additional method embodiments, moving the sensor pair to the second location comprises moving the sensor pair along one or more rails.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts the use of an open cavity tunable diode laser-based methane emissions sensor to determine enteric fermentation generated elevated background methane concentration by attaching it to a bovine ear-tag, according to one embodiment;

FIG. 2 depicts a plan view of a combined mesh sensor network having both emissions and windspeed/direction sensor pairs, according to one embodiment;

FIG. 3 depicts an elevation view of the combined mesh sensor network having both emissions and windspeed/direction sensor pairs highlighting the three-dimensional placement of the sensor pairs around the industrial site, according to one embodiment;

FIG. 4 depicts a schematic of complex boundary layer flows requiring the use of dense sensor mesh networks that combine both wind speed/direction and emissions concentrations, according to one embodiment;

FIG. 5A depicts the sensors constrained to be part of a physical network allowing for a fixed range of motion of the sensor pairs around the industrial facility, according to one embodiment;

FIG. 5B depicts the location of the sensors after they have been installed on the physical network of FIG. 5A and after movement of at least one of the sensors, according to one embodiment;

FIG. 6 depicts the use of color-coded LEDs on methane sensors to highlight local leak severity (flux or concentration) and as a method to track plume propagation with time, according to one embodiment;

FIG. 7 depicts a system utilizing an augmented reality solution to enhance field operations;

FIG. 8 illustrates an example top-level functional block diagram of a system for measuring emissions in a mesh sensor network, according to one embodiment;

FIG. 9 depicts a high-level flowchart of a method for determining a risk profile in a mesh sensor network, according to one embodiment;

FIG. 10 depicts a high-level flowchart of a method for moving sensor pairs in a mesh sensor network, according to one embodiment;

FIG. 11 illustrates an example top-level functional block diagram of a computing device embodiment, according to one embodiment;

FIG. 12 shows a high-level block diagram and process of a computing system for implementing an embodiment of the system and process, according to one embodiment;

FIG. 13 shows a block diagram and process of an exemplary system in which an embodiment may be implemented, according to one embodiment;

FIG. 14 depicts a cloud-computing environment for implementing an embodiment of the system and process disclosed herein, according to one embodiment; and

FIG. 15 depicts a system for detecting trace gasses, according to one embodiment.

### DETAILED DESCRIPTION

The following description is made for the purpose of illustrating the general principles of the embodiments discloses herein and is not meant to limit the concepts disclosed herein. Further, particular features described herein can be used in combination with other described features in each of the various possible combinations and permutations. Unless otherwise specifically defined herein, all terms are to be given their broadest possible interpretation including meanings implied from the description as well as meanings understood by those skilled in the art and/or as defined in dictionaries, treatises, etc.

The present system allows for novel uses and deployments of methane emissions monitoring sensors. In some embodiments, these sensors may be open cavity sensors. In other embodiments, different sensor types may be used.

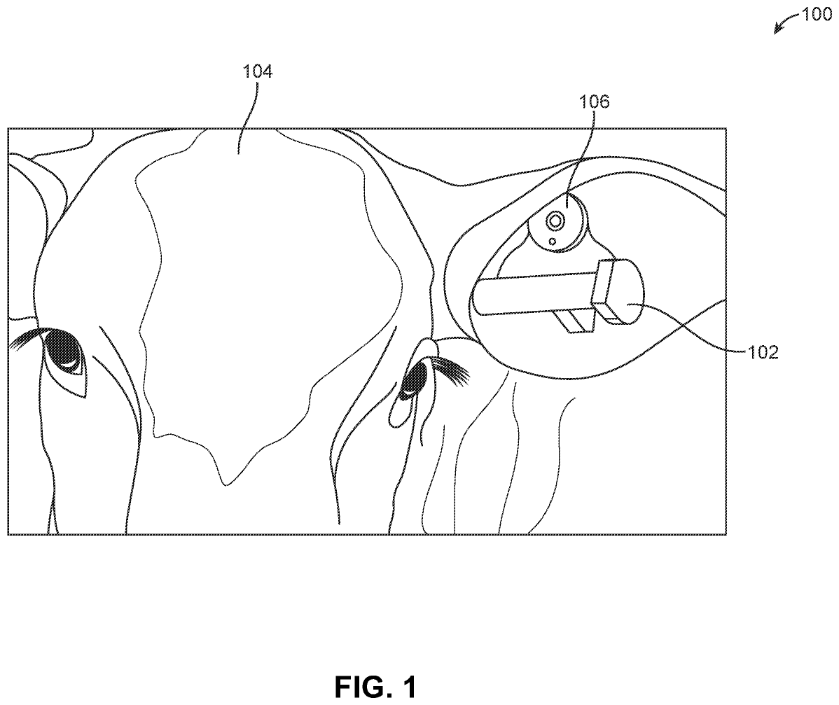

FIG. 1 depicts a system 100 utilizing an open cavity tunable diode laser-based methane emissions sensor 102 to determine enteric fermentation generated elevated background methane concentration by attaching it to a bovine 104 ear-tag 106. Enteric fermentation provides improved estimates of background methane emissions concentrations. Although estimates are made of the emissions that result from enteric fermentation, and used to distinguish these emissions from anthropogenic emissions from industrial operation (oil and gas, etc.), it may be useful to achieve a better estimate of the total emissions, particularly in a dairy or livestock facility that is also producing renewable natural gas (RNG) via a biodigestion process. To this end, the system may utilize a ‘sniffer’ open cavity laser, because of its small, lightweight design and low power requirements, and partner this open cavity laser with a solar cell or a long-life battery, or other energy-harvesting technology, such as a piezo-electric generator, and have the sensor/power package clipped to the ear of cattle 104, pigs, or the like. Each device may have a unique identifier so that one can also take advantage of the inbuilt GPS to know the location and path of the cattle as well as the evolution of the methane in their vicinity. A high density of cattle will also be able (in a semi-fixed location such as a field), to give a time history of the methane production in that location so that it can update the background methane count (which may be above that in non-bovine/swine locations which is approximately 1850 ppb methane concentration).

In some embodiments, the system 100 shown in FIG. 1 may be used at biogas facilities for determining background trace gas readings as compared to trace gas readings from the livestock, and trace gas readings from the processing facilities. In some embodiments, the system may be used to determine a much better estimate globally of the contribution of background, livestock, and processing facility trace gas readings to the global trace gas and/or methane budget.

The disclosed system may also provide for improved emissions plume monitoring with onboard (or co-located) sensor-anemometer pairs: Small scale anemometer/vanes (ultrasonic, hot-wire, tube, or even cup) may be co-located with the emissions sensor(s) to give an accurate representation of both windspeed/direction and emission concentration over a mesh layout of emissions-windspeed sensor pairs. This disclosed combination would provide more detailed and accurate information about the spatial and temporal evolution of a plume, including details of complex boundary layer flow patterns and turbulent swirls, that could lead to the presence of seemingly high upwind concentrations, particularly if the mesh network was fully 3D, varying across a horizontal 2D plane and with some degree of vertical sensor distribution.

In some embodiments, sensors 102 may be located around the digestate at a biogas facility. In some embodiments, sensors 102 may be located around processed digestate (as it seems as if that still emits trace gas and/or methane). In some embodiments, sensors 102 may be located around pens on farms to get a better estimate of background. In some embodiments, sensors 102 may be located around the perimeter of landfill sites. In some embodiments, sensors 102 may be located on the wellheads of landfill sites.

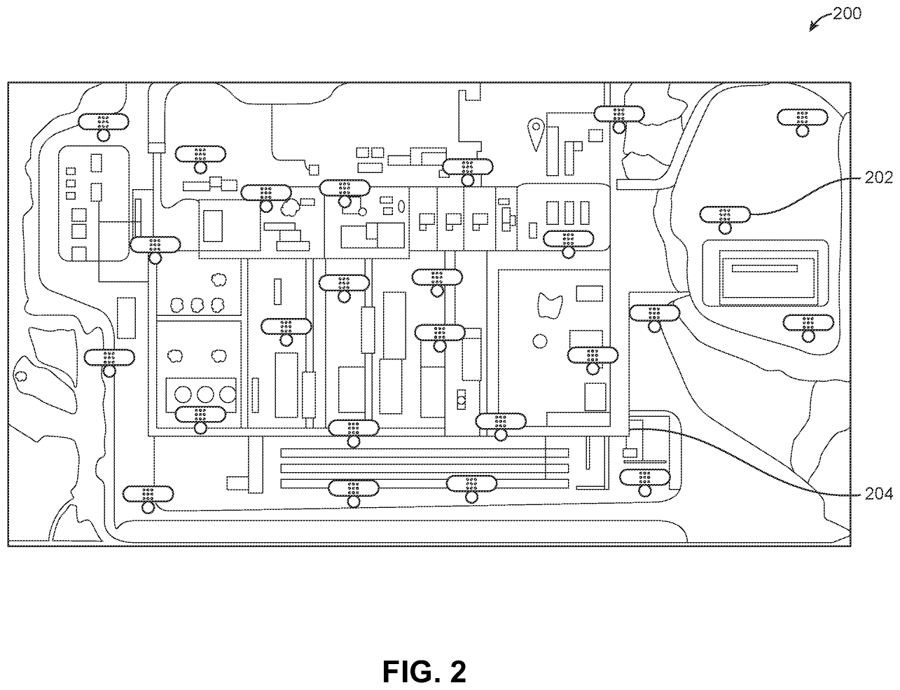

FIG. 2 depicts a plan view of a combined mesh sensor network 200 having both emissions and windspeed/direction sensor pairs 202. The windspeed/direction sensor pairs 202 are distributed throughout oilfield equipment 204. The sensor mesh network 200 may be an irregular mesh sensor network. The sensor mesh network 200 does not have to be regular but can be irregular. This density could be such that there are a more dense set of sensors near the equipment 204 that is most likely to leak and a sparser density of sensors where there is little equipment or a smaller risk of leaks. In addition to the density of sensors varying around the location, in some embodiments the sensors may be of different sensitivities and/or accuracies depending on a likelihood of risk. The likelihood of risk may be based on prior historical leak data, equipment specifications, modelling data, and the like. In some embodiments, more accurate sensors may be located in the vicinity of the higher risk equipment (to better enable quantification measurements). In other embodiments, the higher sensitivity sensors may be located closer to lower leak risk equipment, to have a better chance at detecting a leak. In some embodiments, the sensors may have different sensitivities, with coarse, or low-resolution sensors in areas that are less likely to leak (based on equipment specifications, previous history, a machine learning system, and the like), and higher resolution, more accurate, and/or a denser mesh network of sensors in higher risk regions.

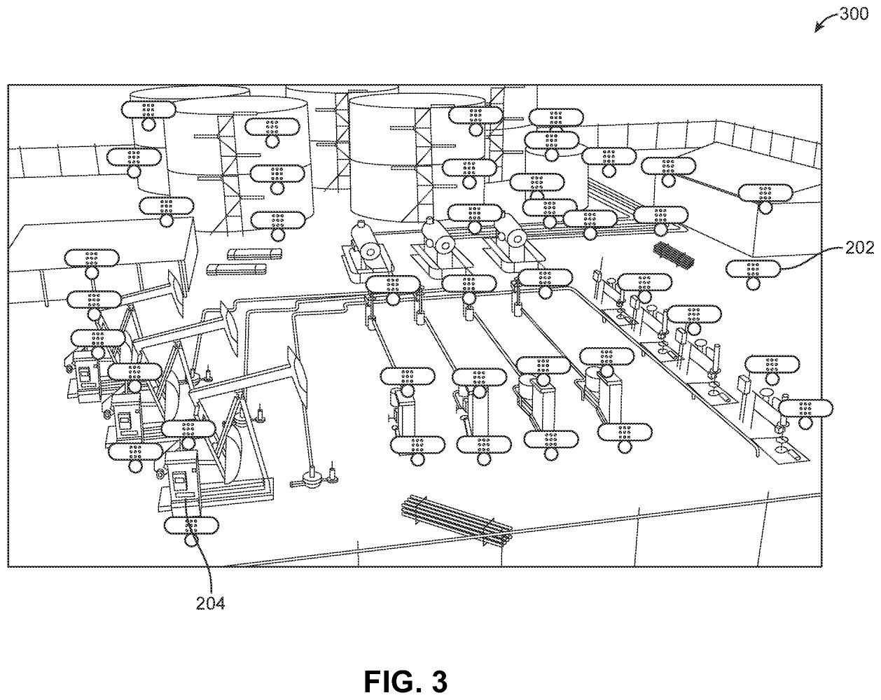

FIG. 3 depicts an elevation view of a combined mesh sensor network 300 having both emissions and windspeed/direction sensor pairs 202 highlighting the three-dimensional placement of the sensor pairs 202 around the industrial site. The windspeed/direction sensor pairs 202 are distributed throughout oilfield equipment 204. FIG. 3 shows that the mesh sensor pairs 202 are distributed both in the horizontal plane and in the vertical plane to increase coverage and improve the ability to track and understand complex boundary layer meteorological flows.

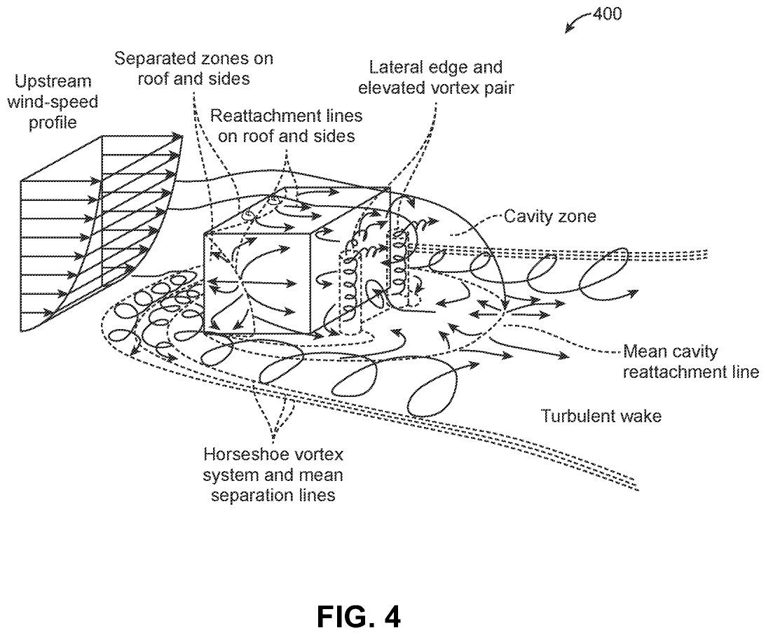

FIG. 4 depicts a schematic of complex boundary layer flows 400 requiring the use of dense sensor mesh networks that combine both wind speed/direction and emissions concentrations. FIG. 4 shows how a plume concentration front may be tracked over time to give more confidence in the back-calculation of the point of origin of the emission(s). The mesh network is shown in the context of oilfield operations and the detection, localization, and quantification of leaks from typical oilfield equipment. However, the system disclosed herein is not restricted to just oilfields and could similarly apply to renewable natural gas operations (landfill, biodigesters, etc.). In some embodiments, the sensor network may be wired or wireless. Examples of a wireless sensor mesh network are disclosed below.

In some embodiments, the mesh sensor pairs may be self-powered (in addition to looking at solar power, battery, and/or wind-power generated), harnessing any environmental vibrations or thermal differences, or using thermoelectric materials. This would add to the carbon-neutral nature and the environmental friendliness of the system offering.

FIG. 4 highlights the types of flows 400 that could be seen in both the near-surface and mixed layer, with strong diurnal forcing and vortex shedding, small scale eddy creation due to the presence of the surface equipment, and the shear that typically occurs. Indeed, the vertical distribution of the sensor pairs will be essential for accurate representation and understanding of the boundary layer flows to ensure precise localization of the emissions source. Wind shear is typically responsible for the horizontal transport of pollutants/emissions, while buoyancy (convective heating, etc.) dominates the vertical mixing.

In some embodiments, there may be an element of mobility to the sensors such that the sensors form a mobile sensor mesh. Useful applications utilizing this mobile sensor mesh may allow the system to better refine the accuracy of the localization and quantification of emissions. Mobility could be by a number of methods described below.

In one embodiment, the sensors may be set up in the 3D space on rails and/or tracks so that the sensors can move along constrained trajectories. An operator could then direct the sensors to the desired locations, either to a region that they anticipate could be an area of high potential leak risk, or removing the sensors from the lower risk areas.

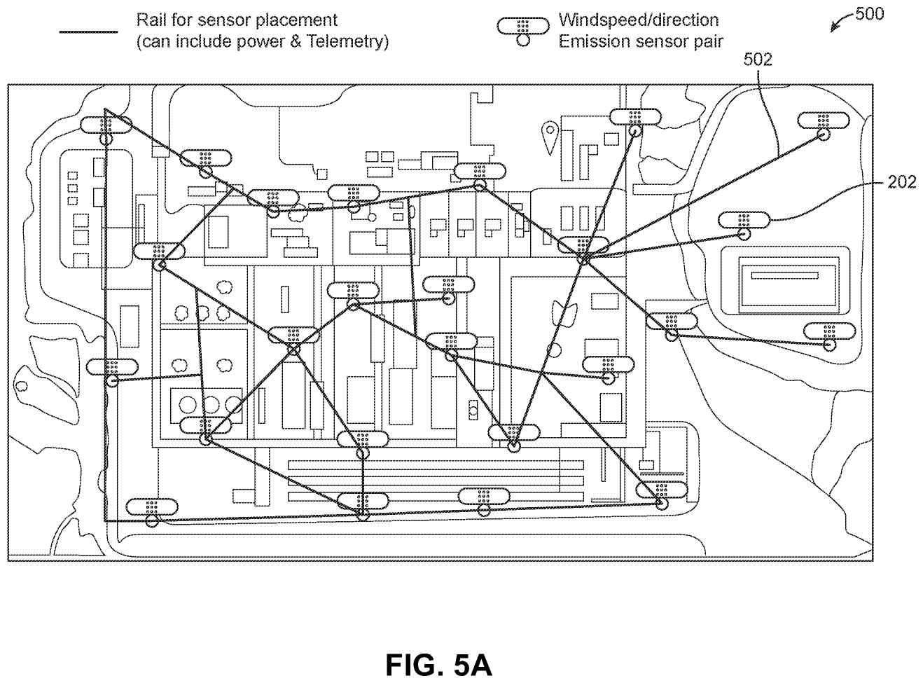

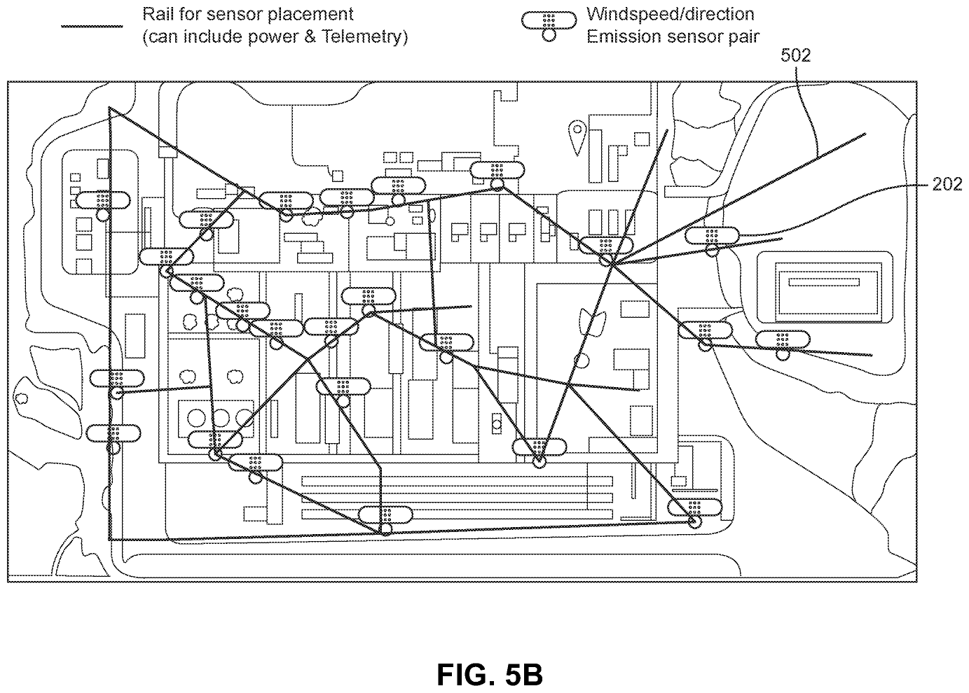

FIG. 5A shows the sensors constrained to be part of a physical network 500 allowing for a fixed range of motion of the sensor pairs 202 around the industrial facility. FIG. 5B shows the location of the sensor pairs 202 after they have been installed on the physical network 500 of FIG. 5A and after the movement of at least one of the sensor pairs 202. The sensor pairs 202 may be moved, either manually or under their own power (the rails 502 that the sensor pairs 202 sit on could also act as power (and telemetry conduit for the sensors), to the more high-risk leak areas. In some embodiments, the sensor pairs 202 may still be ‘wireless’ in terms of their power and communication, and the rails 502 may act as a pure scaffold and network for the sensors to move or be placed along.

Rail placement may be designed such that the rails 502 cover the majority of the site in terms of vertical and lateral extent, but would not impact day-to-day operations, and still allow for full and unencumbered movement around the site. Coverage would be such that (if it were an oil and gas production facility, for example), all major equipment groups that could leak would be encompassed, e.g., as high as the flare, and out to the tanks, separators etc. Sensor placement (and density and sensitivity) may be based on customer needs, but would ensure that all high risk equipment types are monitored, and those where high rates could be expected would be covered by a higher density of sensors to enable more accurate quantification. The sensors may be able to move in some embodiments. In other embodiments, the sensors may be fixed until requested to move to a different location, or dynamically retasked based on their measurements, e.g., as indicated in FIG. 5B, and moved into a higher density network, to again, better facilitate a more accurate quantification.

Additionally, the sensor pairs 202 may also understand the risk profile for the equipment that they are sensing and move under their own ‘initiative’ to the regions of highest risk of a leak. Risk of a leak is based on a number of factors. In some embodiments, some or all of these factors may be combined to give a leak risk probability. Historical maintenance information may be a factor for risk of a leak. Historical maintenance information may include information such as whether a particular piece of equipment, or from a particular manufacturer, leaks more than another. The factors for risk of a leak may be refined as more data is acquired, enabling the probability of leak to change.

This could be based on the intelligence built into the system using some of, but not limited to, the following information: a history of specific equipment leak risk; a time since the last leak; a history of actual leaks; and a time since last maintenance/repair. The sensor pairs 202 could then adaptively move into either locations that have a higher risk of a leak or areas of the equipment layout that the system is not adequately currently represented. In some embodiments, multiple sensors may be moved to congregate in one area of concern via dynamic retasking. Dynamic retasking may be used to provide sufficient density of spatial coverage to enable a more accurate quantification of a leak once detected.

In some embodiments, the mobility of the sensor pairs 202 could be due to various equipment that periodically or systematically visits the location. This could be service equipment, fuel trucks, supply or safety vehicles, or the like. All of these could be equipped with methane sensors that then give a snapshot of the methane profile on location given the history of their movement about the site via the time history of their GPS. This sporadic and asynchronous data could be spliced into the overall time history of the evolution of the methane presence at the location. In addition, the system disclosed herein may continue to add in drone-based measurements, all in service in refining and reducing the uncertainty in leak rate and position. In some embodiments, the sensors may be permanently attached to the equipment. In other embodiments, the sensors may be added to the equipment when visiting the site. In one embodiment, supply trucks attend multiple wellsite locations, delivering equipment, supplies and personnel and one or more sensors may be attached to the supply truck to obtain additional coverage, and also obtain some background readings between sites.

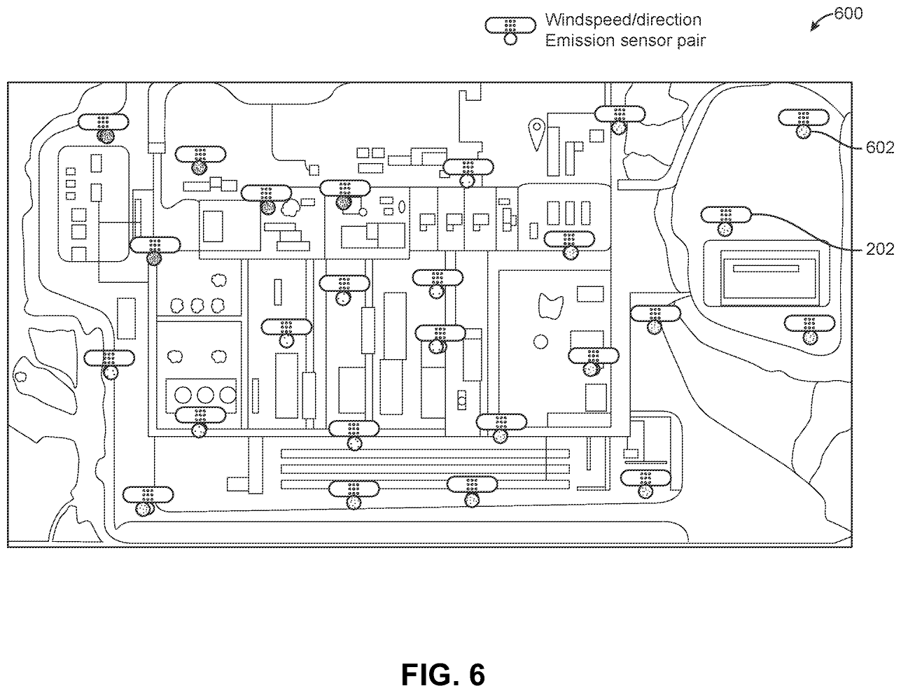

FIG. 6 depicts the use of color-coded LEDs 602 on methane sensor pairs 202 in a network 600 to highlight local leak severity (flux or concentration), and as a method to track plume propagation with time. The disclosed system may be used to indicate the severity of a methane leak. Each of the sensor pairs 202 in the mesh may have a low-power LED 602 that (based on a predetermined or adaptive threshold) indicate the severity of the leak in its proximity. As an example, the LED 602 may illuminate as red for high leak rate/flux or concentration, orange for intermediate hazard, and green for below threshold. The evolution of the pattern of red, yellow, and green may be analyzed to see the front of the leak plume over time. FIG. 6 highlights in the sensor mesh network 600 the use of this color-coding in the example application and mesh layouts from FIGS. 2 and 5A.

The viewing of these colors may be by workers on location, who get alerted to a leak at a certain threshold and issue a STOP Work order, or if yellow alert the facility manager. In some embodiments, the indicators may be a part of an automated system in which certain actions are taken. In some embodiments, a facility HSE or plant manager may have a ‘playbook’ for what actions they will take according to the severity (yellow vs red). In other embodiments, there may be systems that correlate the various leaks together to give an elevated risk, or to identify which equipment groups may be more susceptible to leaks and thus require additional investigation, such as a detailed examination by an Optical Gas Imaging camera.

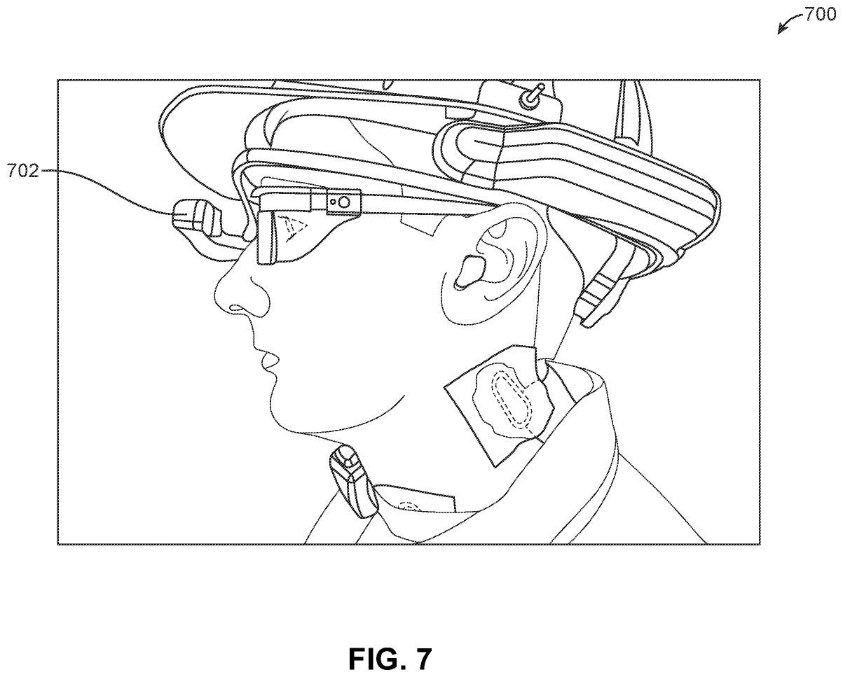

FIG. 7 depicts a system utilizing an augmented reality solution 700 to enhance field operations. In one embodiment, the augmented reality hardware 702 may be RealWear Connected Hardware. Other augmented reality hardware devices are possible and contemplated. Augmented reality tools may be used to aid with repairs. With augmented reality and virtual reality tools, one can ‘walk’ the site and visualize the plume with its placement as a graduated color scheme as a function of flux plume leak rate (or local concentration) in the context of the local equipment, enabling the leak point to be identified in 3D space and then investigated by the technician/repair team. Technologies such as Google Glass and RealWear enable the projection of information hands-free. The disclosed system may utilize an AR/VR headset, projected 3D plume based on interpreted leak measurement data, and then the workflow or checklist needed to be followed to secure the facility and fix the leak, and inform all those who need the relevant information. Leak Detection and Repair (LDAR) work instructions or checklists may be followed by repair groups such as TEAM or Insight Environmental or FLIR.

The type of images from optical cameras that may be overlaid with the quantification results from the mesh sensors may include the superposition of the numerical leak rate calculated from the system quantification algorithms as part of the head-up display (HUD) in the AR/VR system with the OGI images. The AR/VR system may then call up the maintenance checklist specific to that piece of equipment, so that the field/operations worker can safely shut-off the leak and repair the leaking module, but following a standard list of instructions in his HUD, enabling him to follow step-by-step to effect the repair. The overlay of our leak quantification rates over any OGI images as the visual source is provided in the system and methods disclosed herein. The systems and methods disclosed herein provide for the ability to call up manuals or even interact with a helpdesk in real-time to work remotely on a particularly difficult fix.

In some embodiments, the HUD may, based on the quantification and localization analysis, based on the mesh network, or the mesh in concert with additional information, e.g., drone-based measurements, highlight the leaks by leak rate so that the largest ones would be flagged (or color-coded), and then by voice command (or automatically) the mesh could be dynamically retasked to give a refined estimates or refined estimates for multiple leak sources.

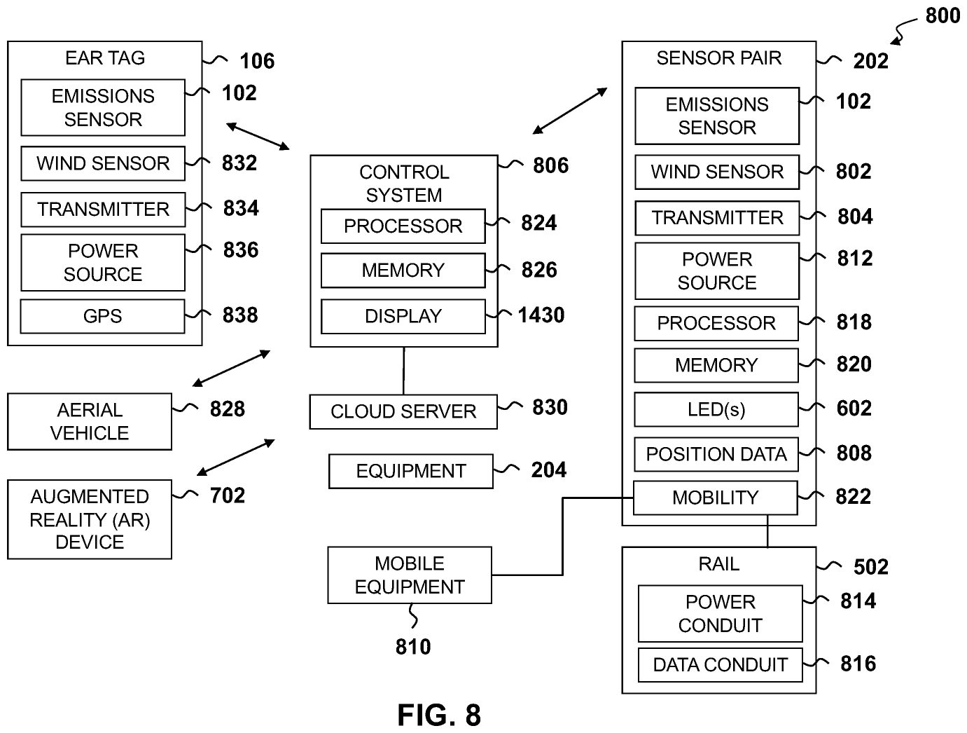

FIG. 8 illustrates an example top-level functional block diagram of a system 800 for measuring emissions in a mesh sensor network. The system may include a sensor pair 202 for measuring trace gas measurements from one or more emissions sensors 102 and a wind sensor 802 such as an anemometer for measuring wind speed and/or wind direction. The system 800 may be used to identify a trace gas leak in equipment 204, such as oil field equipment. In some embodiments, the sensor pair 202 may also include a transmitter 804 for transmitting gas data, wind data, and/or location data to a control system 806. In some embodiments, data from the sensor pair 202 may be transmitted to the control system 806 via a data conduit 816 of the rail 502. The sensor pair 202 may have location data from a position data 808. In some embodiments, the position data 808 may be from a position sensor, a global positioning system (GPS), a triangulation, and/or a manually entered or calculated position information. Position data 808 may include local or global coordinate systems. Position data 808 may be relative to a potential emissions source or other objects. In some embodiments, the position data 808 may be a part of the sensor pair 202. In other embodiments, the position data 808 may be from an external source, such as a mobile equipment 810 that the sensor pair 202 is attached to. In some embodiments, the position data 808 may be any other location measurement system, such as triangulation.

The sensor pair 202 may include a power source 812 in some embodiments. The power source 812 may be a battery. In some embodiments, the power source 812 may be recharged, such as via a connected solar panel or power conduit 814 in a rail 502.

The sensor pair 202 may include a processor 818 having addressable memory 820. The processor 818 may understand the risk profile for the equipment that they are sensing and move under their own ‘initiative’ (such as via mobility 822) to the regions of highest risk of a leak. The processor 818 may utilize one or more of the following information: a history of specific equipment leak risk; a time since the last leak; a history of actual leaks; and a time since last maintenance/repair. In some embodiments, these information types may be updated in response to new measurements. In other embodiments, these information types may be tied to an Edge processing system that may have access to a broader history of equipment maintenance/leak/repair history, and also may have access to a machine learning system on the edge that could also assist in the optimization of sensor replacement or dynamically retask the sensors. The processor 818 may then adaptively move the sensor pair 202 into either locations that have a higher risk of a leak, or areas of the equipment layout that the system is not adequately currently represented. In some embodiments, these processor 818 functions may be carried out by a processor 824 having addressable memory 826 of the control system 806 or a processor of a cloud server 830.

One or more LEDs 602 of the sensor pair 202 may, based on a predetermined or adaptive threshold, indicate a severity of the leak in the proximity of the sensor pair 202. In some embodiments, the processor 818 of the sensor pair 202 and/or the processor 824 of the control system 806 may analyze the evolution of the pattern of LED colors to see the front of the leak plume over time.

In some embodiments, the sensor pair 202 may have mobility 822. The mobility 822 may be a separate mobility device, such as one or more motors, rotors, tracks, or the like. The mobility 822 may allow the sensor pair 202 to move on a rail 502. The mobility 822 may allow the sensor pair 202 to be attached to mobile equipment 810, such as service equipment, fuel trucks, supply or safety vehicles, or the like.

One or more sensor pairs 202 may be located proximate to a possible source of a trace gas. Data from the one or more sensor pairs 202 may be used in addition to data from mobile equipment 810 such as mobile equipment having one or more emissions sensors, an aerial vehicle 828 such as an unmanned aerial vehicle (UAV) having one or more emissions sensors, one or more handheld emissions sensors, one or more ear tags 106, and the like.

An ear tag 106 may be attached to the ear of livestock. The ear tag 106 may include an emissions sensor 102, a wind sensor 832, a transmitter 834, a power source 836, and/or a GPS 838. In some embodiments, the GPS 838 may be used to both track the location where wind and gas data are being generated as well as to track the location of the livestock to which the ear tag 106 is attached.

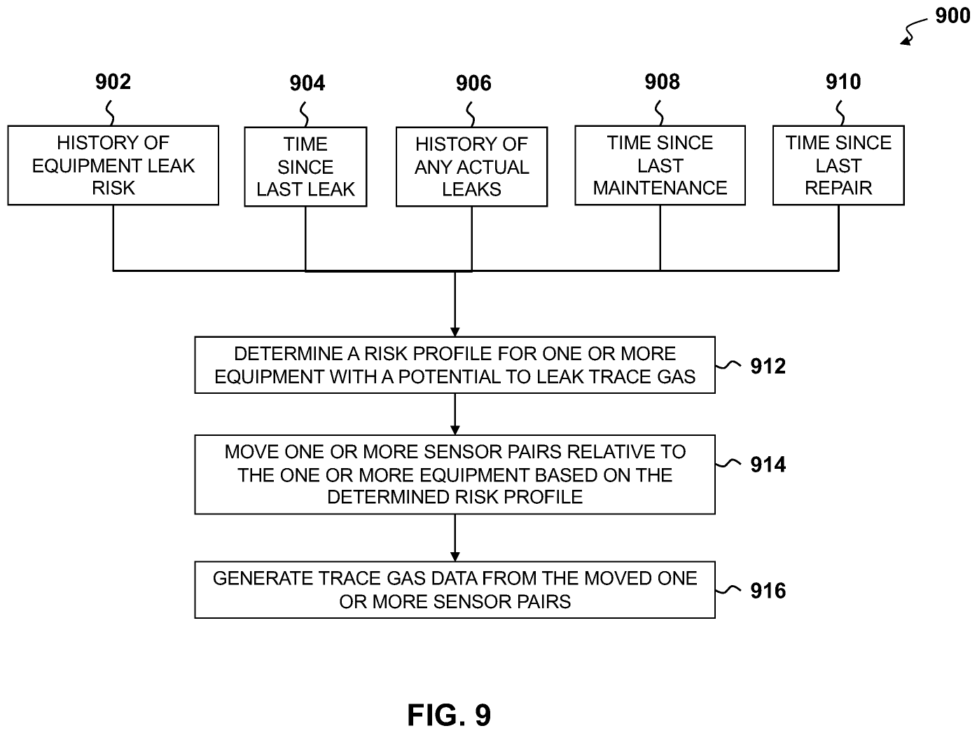

FIG. 9 depicts a high-level flowchart of a method 900 for determining a risk profile in a mesh sensor network, according to one embodiment. The method 900 may include determining a risk profile for one or more equipment with a potential to leak trace gas (step 912). The risk profile factors may include a history of equipment leak risk (902), a time since a last leak (904), a history of any actual leaks (906), a time since last maintenance (908), and a time since last repair (910). In some embodiments, machine learning an/or AI tools may be used to analyze the complex range of information around leaks and how repairs should be prioritized in the context of current operations. The oilfield equipment that has been repaired multiple times or has been operating without maintenance for extensive periods may be the most likely to leak, but there are many other parameters that need to be considered such as the operating environment (temperature), proficiency of operators, and the like. The method 900 may then include moving one or more sensor pairs relative to the one or more equipment based on the determined risk profile (step 914). The method 900 may then include generating trace gas data from the moved one or more sensor pairs (step 916). The one or more sensor pairs may also generate wind data, which may include wind speed and wind direction. The one or more sensor pairs may also generate location data to correspond the location to the gas data and/or wind data. In some embodiments, this method 900 may be an iterative loop whereby sensors may shuttle back and forth depending on how the uncertainty of the leak rate is reduced.

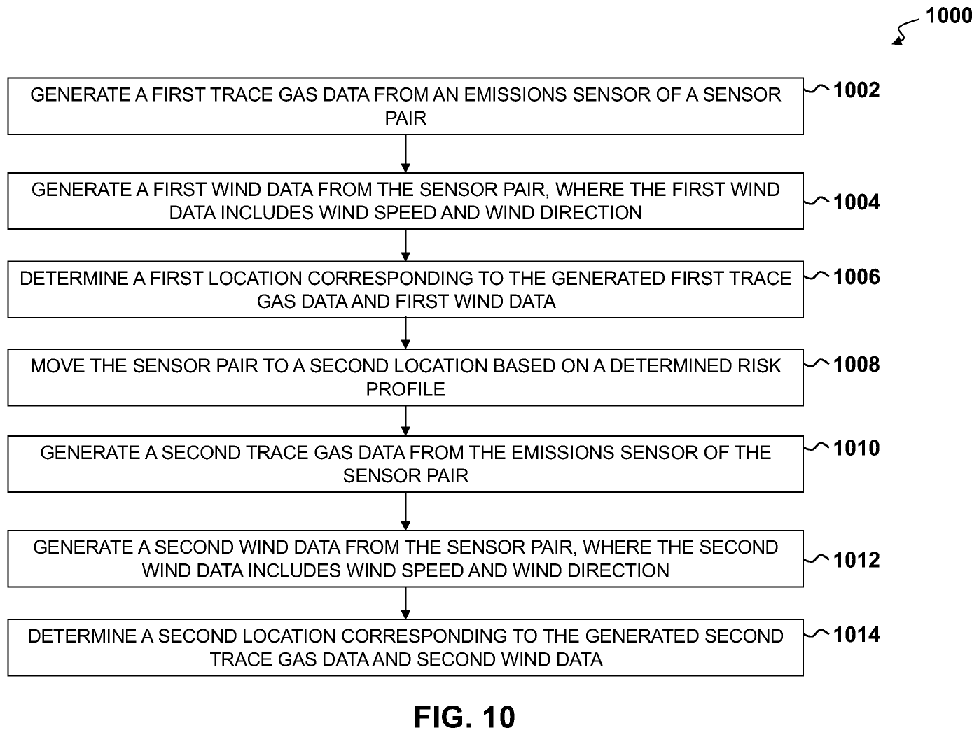

FIG. 10 depicts a high-level flowchart of a method 1000 for moving sensor pairs in a mesh sensor network, according to one embodiment. The method 1000 may include generating a first trace gas data from an emissions sensor of a sensor pair (step 1002). The sensor pair may include a gas sensor and a wind sensor. The method 1000 may then include generating a first wind data from the sensor pair, where the first wind data includes the wind speed and the wind direction (step 1004). The method 1000 may then include determining a first location corresponding to the generated first trace gas data and first wind data (step 1006). The method 1000 may then include moving the sensor pair to a second location based on a determined risk profile (step 1008). The method 1000 may then include generating a second trace gas data from the emissions sensor of the sensor pair (step 1010). The method 1000 may then include generating a second wind data from the sensor pair, where the second wind data includes the wind speed and wind direction (step 1012). The method 1000 may then include determining a second location corresponding to the generated second trace gas data and second wind data (step 1014). The method 1000 may include generating trace gas data and/or wind data at additional locations. In some embodiments, the method 1000 may be iterative, with sensors moving closer as an uncertainty cost function is calculated and reduced. There will be an optimum location, whereby the system may be prohibited from getting closer (if the sensor is not ATEX rated), or where the uncertainty in localization and quantification cannot be reduced to any further degree, or where there are multiple leaks and the sensors need to move to a newer location to estimate that leak. As a result, the methods disclosed herein may feed the system that would be triaging the repairs.

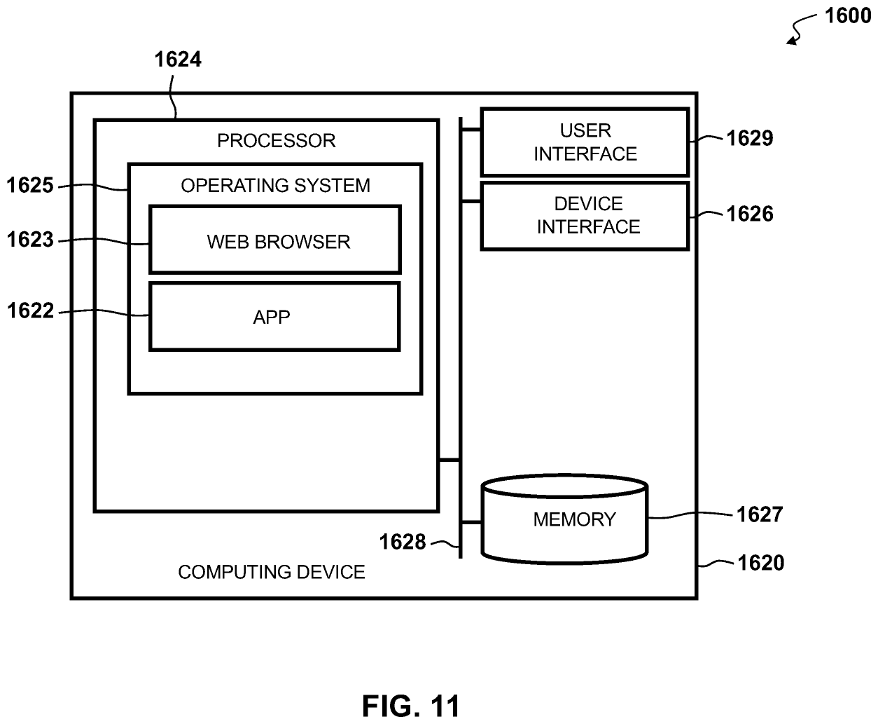

FIG. 11 illustrates an example of a top-level functional block diagram of a computing device embodiment 1600. The example operating environment is shown as a computing device 1620 comprising a processor 1624, such as a central processing unit (CPU), addressable memory 1627, an external device interface 1626, e.g., an optional universal serial bus port and related processing, and/or an Ethernet port and related processing, and an optional user interface 1629, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 1628. In some embodiments, via an operating system 1625 such as one supporting a web browser 1623 and applications 1622, the processor 1624 may be configured to execute steps of a process establishing a communication channel and processing according to the embodiments described above.

System embodiments include computing devices such as a server computing device, a buyer computing device, and a seller computing device, each comprising a processor and addressable memory and in electronic communication with each other. The embodiments provide a server computing device that may be configured to: register one or more buyer computing devices and associate each buyer computing device with a buyer profile; register one or more seller computing devices and associate each seller computing device with a seller profile; determine search results of one or more registered buyer computing devices matching one or more buyer criteria via a seller search component. The service computing device may then transmit a message from the registered seller computing device to a registered buyer computing device from the determined search results and provide access to the registered buyer computing device of a property from the one or more properties of the registered seller via a remote access component based on the transmitted message and the associated buyer computing device; and track movement of the registered buyer computing device in the accessed property via a viewer tracking component. Accordingly, the system may facilitate the tracking of buyers by the system and sellers once they are on the property and aid in the seller's search for finding buyers for their property. The figures described below provide more details about the implementation of the devices and how they may interact with each other using the disclosed technology.

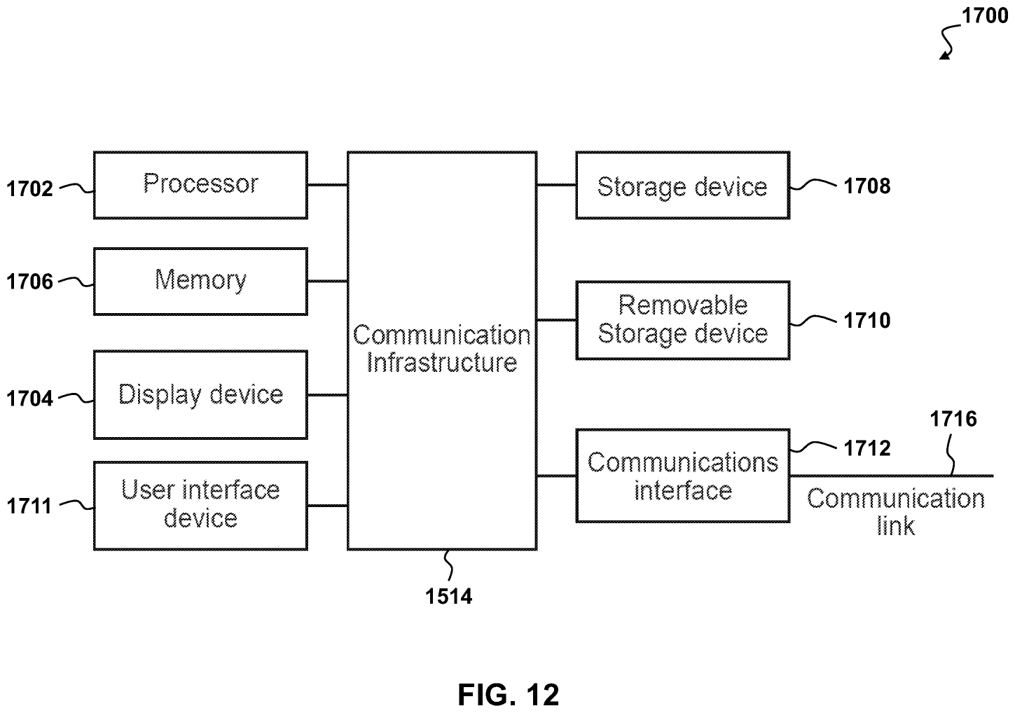

FIG. 12 is a high-level block diagram 1700 showing a computing system comprising a computer system useful for implementing an embodiment of the system and process, disclosed herein. Embodiments of the system may be implemented in different computing environments. The computer system includes one or more processors 1702, and can further include an electronic display device 1704 (e.g., for displaying graphics, text, and other data), a main memory 1706 (e.g., random access memory (RAM)), storage device 1708, a removable storage device 1710 (e.g., removable storage drive, a removable memory module, a magnetic tape drive, an optical disk drive, a computer readable medium having stored therein computer software and/or data), user interface device 1711 (e.g., keyboard, touch screen, keypad, pointing device), and a communication interface 1712 (e.g., modem, a network interface (such as an Ethernet card), a communications port, or a PCMCIA slot and card). The communication interface 1712 allows software and data to be transferred between the computer system and external devices. The system further includes a communications infrastructure 1714 (e.g., a communications bus, cross-over bar, or network) to which the aforementioned devices/modules are connected as shown.

Information transferred via communications interface 1714 may be in the form of signals such as electronic, electromagnetic, optical, or other signals capable of being received by communications interface 1714, via a communication link 1716 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1712. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

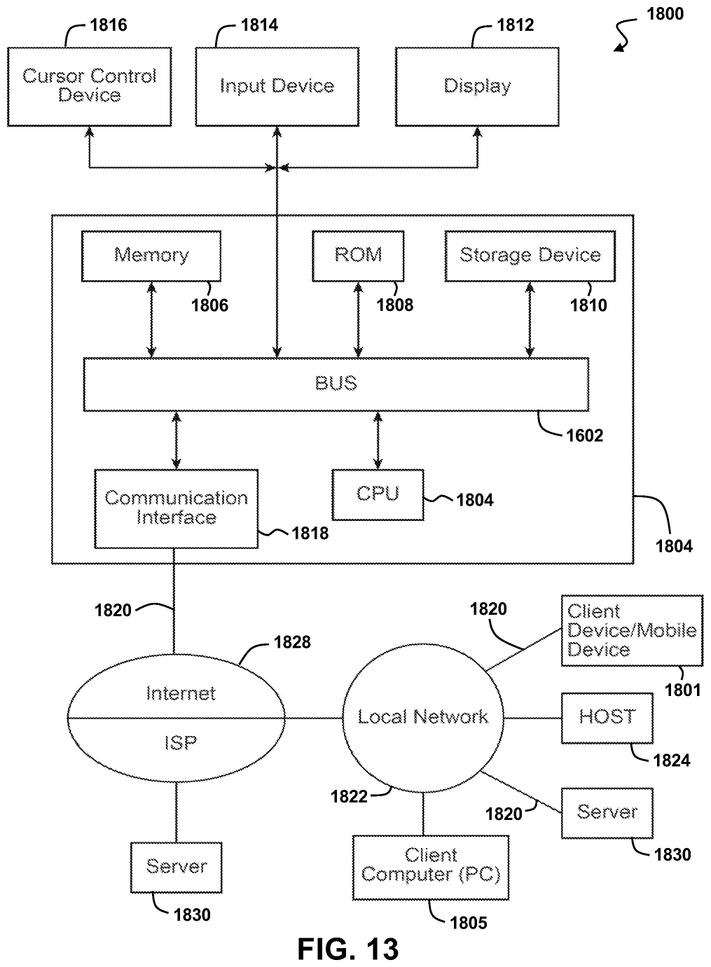

FIG. 13 shows a block diagram of an example system 1800 in which an embodiment may be implemented. The system 1800 includes one or more client devices 1801 such as consumer electronics devices, connected to one or more server computing systems 1830. A server 1830 includes a bus 1802 or other communication mechanism for communicating information, and a processor (CPU) 1804 coupled with the bus 1802 for processing information. The server 1830 also includes a main memory 1806, such as a random access memory (RAM) or other dynamic storage device, coupled to the bus 1802 for storing information and instructions to be executed by the processor 1804. The main memory 1806 also may be used for storing temporary variables or other intermediate information during execution or instructions to be executed by the processor 1804. The server computer system 1830 further includes a read only memory (ROM) 1808 or other static storage device coupled to the bus 1802 for storing static information and instructions for the processor 1804. A storage device 1810, such as a magnetic disk or optical disk, is provided and coupled to the bus 1802 for storing information and instructions. The bus 1802 may contain, for example, thirty-two address lines for addressing video memory or main memory 1806. The bus 1802 can also include, for example, a 32-bit data bus for transferring data between and among the components, such as the CPU 1804, the main memory 1806, video memory and the storage 1810. Alternatively, multiplex data/address lines may be used instead of separate data and address lines.

The server 1830 may be coupled via the bus 1802 to a display 1812 for displaying information to a computer user. An input device 1814, including alphanumeric and other keys, is coupled to the bus 1802 for communicating information and command selections to the processor 1804. Another type or user input device comprises cursor control 1816, such as a mouse, a trackball, or cursor direction keys for communicating direction information and command selections to the processor 1804 and for controlling cursor movement on the display 1812.

According to one embodiment, the functions are performed by the processor 1804 executing one or more sequences of one or more instructions contained in the main memory 1806. Such instructions may be read into the main memory 1806 from another computer-readable medium, such as the storage device 1810. Execution of the sequences of instructions contained in the main memory 1806 causes the processor 1804 to perform the process steps described herein. One or more processors in a multi-processing arrangement may also be employed to execute the sequences of instructions contained in the main memory 1806. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1804 for execution. Such a medium may take many forms, including but not limited to, non-volatile media, volatile media, and transmission media. Non-volatile media includes, for example, optical or magnetic disks, such as the storage device 1810. Volatile media includes dynamic memory, such as the main memory 1806. Transmission media includes coaxial cables, copper wire and fiber optics, including the wires that comprise the bus 1802. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1804 for execution. For example, the instructions may initially be carried on a magnetic disk of a remote computer. The remote computer can load the instructions into its dynamic memory and send the instructions over a telephone line using a modem. A modem local to the server 1830 can receive the data on the telephone line and use an infrared transmitter to convert the data to an infrared signal. An infrared detector coupled to the bus 1802 can receive the data carried in the infrared signal and place the data on the bus 1802. The bus 1802 carries the data to the main memory 1806, from which the processor 1804 retrieves and executes the instructions. The instructions received from the main memory 1806 may optionally be stored on the storage device 1810 either before or after execution by the processor 1804.

The server 1830 also includes a communication interface 1818 coupled to the bus 1802. The communication interface 1818 provides a two-way data communication coupling to a network link 1820 that is connected to the world wide packet data communication network now commonly referred to as the Internet 1828. The Internet 1828 uses electrical, electromagnetic or optical signals that carry digital data streams. The signals through the various networks and the signals on the network link 1820 and through the communication interface 1818, which carry the digital data to and from the server 1830, are exemplary forms or carrier waves transporting the information.

In another embodiment of the server 1830, interface 1818 is connected to a network 1822 via a communication link 1820. For example, the communication interface 1818 may be an integrated services digital network (ISDN) card or a modem to provide a data communication connection to a corresponding type of telephone line, which can comprise part of the network link 1820. As another example, the communication interface 1818 may be a local area network (LAN) card to provide a data communication connection to a compatible LAN. Wireless links may also be implemented. In any such implementation, the communication interface 1818 sends and receives electrical electromagnetic or optical signals that carry digital data streams representing various types of information.

The network link 1820 typically provides data communication through one or more networks to other data devices. For example, the network link 1820 may provide a connection through the local network 1822 to a host computer 1824 or to data equipment operated by an Internet Service Provider (ISP). The ISP in turn provides data communication services through the Internet 1828. The local network 1822 and the Internet 1828 both use electrical, electromagnetic or optical signals that carry digital data streams. The signals through the various networks and the signals on the network link 1820 and through the communication interface 1818, which carry the digital data to and from the server 1830, are exemplary forms or carrier waves transporting the information.

The server 1830 can send/receive messages and data, including e-mail, program code, through the network, the network link 1820 and the communication interface 1818. Further, the communication interface 1818 can comprise a USB/Tuner and the network link 1820 may be an antenna or cable for connecting the server 1830 to a cable provider, satellite provider or other terrestrial transmission system for receiving messages, data and program code from another source.

The example versions of the embodiments described herein may be implemented as logical operations in a distributed processing system such as the system 1800 including the servers 1830. The logical operations of the embodiments may be implemented as a sequence of steps executing in the server 1830, and as interconnected machine modules within the system 1800. The implementation is a matter of choice and can depend on performance of the system 1800 implementing the embodiments. As such, the logical operations constituting said example versions of the embodiments are referred to for e.g., as operations, steps or modules.

Similar to a server 1830 described above, a client device 1801 can include a processor, memory, storage device, display, input device and communication interface (e.g., e-mail interface) for connecting the client device to the Internet 1828, the ISP, or LAN 1822, for communication with the servers 1830.

The system 1800 can further include computers (e.g., personal computers, computing nodes) 1805 operating in the same manner as client devices 1801, where a user can utilize one or more computers 1805 to manage data in the server 1830.

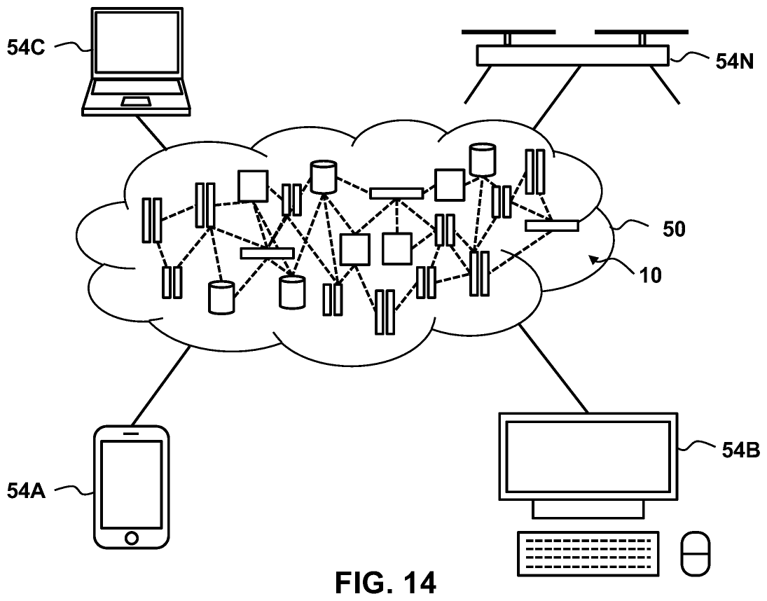

Referring now to FIG. 14, illustrative cloud computing environment 50 is depicted. As shown, cloud computing environment 50 comprises one or more cloud computing nodes 10 with which local computing devices used by cloud consumers, such as, for example, personal digital assistant (PDA), smartphone, smart watch, set-top box, video game system, tablet, mobile computing device, or cellular telephone 54A, desktop computer 54B, laptop computer 54C, and/or unmanned aerial system (UAS) 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 14 are intended to be illustrative only and that computing nodes 10 and cloud computing environment 50 can communicate with any type of computerized device over any type of network and/or network addressable connection (e.g., using a web browser).

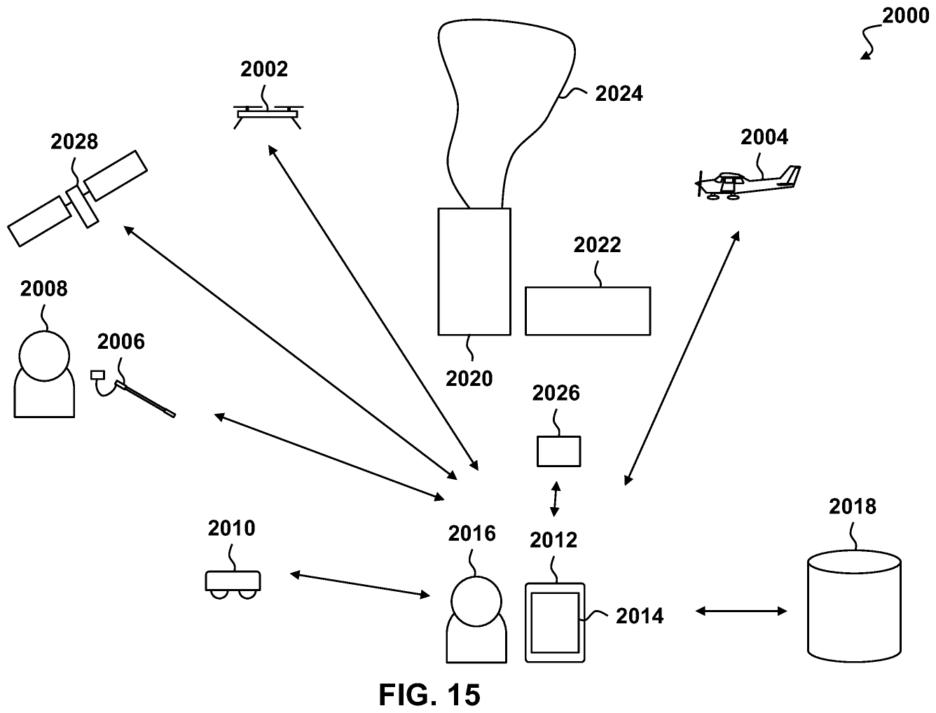

FIG. 15 depicts a system 2000 for detecting trace gasses, according to one embodiment. The system may include one or more trace gas sensors located in one or more vehicles 2002, 2004, 2006, 2010, 2028. The one or more trace gas sensors may detect elevated trace gas concentrations from one or more potential gas sources 2020, 2022, such as a holding tank, pipeline, or the like. The potential gas sources 2020, 2022 may be part of a large facility, a small facility, or any location. The potential gas sources 2020, 2022 may be clustered and/or disposed distal from one another. The one or more trace gas sensors may be used to detect and quantify leaks of toxic gases, e.g., hydrogen disulfide, or environmentally damaging gases, e.g., methane, sulfur dioxide) in a variety of industrial and environmental contexts. Detection and quantification of these leaks are of interest to a variety of industrial operations, such as oil and gas, chemical production, and painting. Detection and quantification of leaks is also of value to environmental regulators for assessing compliance and for mitigating environmental and safety risks. In some embodiments, the at least one trace gas sensor may be configured to detect methane. In other embodiments, the at least one trace gas sensor may be configured to detect sulfur oxide, such as SO, SO2, SO3, S7O2, S6O2, S2O2, and the like. A trace gas leak 2024 may be present in a potential gas source 2020. The one or more trace gas sensors may be used to identify the trace gas leak 2024 and/or the source 2020 of the trace gas leak 2024 so that corrective action may be taken.

The one or more vehicles 2002, 2004, 2006, 2010, 2028 may include an unmanned aerial vehicle (UAV) 2002, an aerial vehicle 2004, a handheld device 2006, a ground vehicle 2010, and a satellite 2028. In some embodiments, the UAV 2002 may be a quadcopter or other device capable of hovering, making sharp turns, and the like. In other embodiments, the UAV 2002 may be a winged aerial vehicle capable of extended flight time between missions. The UAV 2002 may be autonomous or semi-autonomous in some embodiments. In other embodiments, the UAV 2002 may be manually controlled by a user. The aerial vehicle 2004 may be a manned vehicle in some embodiments. The handheld device 2006 may be any device having one or more trace gas sensors operated by a user 2008. In one embodiment, the handheld device 2006 may have an extension for keeping the one or more trace gas sensors at a distance from the user 2008. The ground vehicle 2010 may have wheels, tracks, and/or treads in one embodiment. In other embodiments, the ground vehicle 2010 may be a legged robot. In some embodiments, the ground vehicle 2010 may be used as a base station for one or more UAVs 2002. The satellite 2028 may be used to capture images of a site for identify a trace gas leak 2024 and/or the source 2020 of the trace gas leak 2024. In some embodiments, one or more aerial devices, such as the UAV 2002, a balloon, or the like, may be tethered to the ground vehicle 2010. In some embodiments, one or more trace gas sensors may be located in one or more stationary monitoring devices 2026. The one or more stationary monitoring devices may be located proximate one or more potential gas sources 2020, 2022. In some embodiments, the one or more stationary monitoring devices may be relocated.

The one or more vehicles 2002, 2004, 2006, 2010, 2028 and/or stationary monitoring devices 2026 may transmit data including trace gas data to a ground control station (GCS) 2012. The GCS may include a display 2014 for displaying the trace gas concentrations to a GCS user 2016. The GCS user 2016 may be able to take corrective action if a gas leak 2024 is detected, such as by ordering a repair of the source 2020 of the trace gas leak. The GCS user 2016 may be able to control movement of the one or more vehicles 2002, 2004, 2006, 2010, 2028 in order to confirm a presence of a trace gas leak in some embodiments.

In some embodiments, the GCS 2012 may transmit data to a cloud server 2018. In some embodiments, the cloud server 2018 may perform additional processing on the data. In some embodiments, the cloud server 2018 may provide third party data to the GCS 2012, such as wind speed, temperature, pressure, weather data, or the like.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention herein disclosed by way of examples should not be limited by the particular disclosed embodiments described above.

1: A system comprising:
multiple sensors, wherein the multiple sensors comprises:
an emissions sensor configured to generate trace gas data;
a wind sensor configured to generate wind data, wherein the wind data comprises wind speed and wind direction; and
a position sensor providing position data, wherein the position data comprises a location corresponding to the generated trace gas data and generated wind data;
at least one light-emitting device, wherein the at least one light-emitting device is configured to illuminate based on a severity of a gas leak within a proximity to the emissions sensor based on the generated trace gas data and generated wind data.

2: The system of claim 1, wherein detecting the severity of the gas leak is based on a predetermined threshold.

3: The system of claim 1, wherein detecting the severity of the gas leak is based on an adaptive threshold.

4: The system of claim 1, further comprising:
a processor having addressable memory, wherein the processor is configured to:
determine a risk profile for one or more equipment, wherein the one or more equipment have a potential to leak trace gas.

5: The system of claim 4, wherein the determined risk profile is based on at least one of: a history of specific equipment leak risk, a time since a last leak, a history of actual leaks, a time since last maintenance, and a time since last repair.

6: The system of claim 4, wherein the processor is further configured to:
move the multiple sensors relative to the one or more equipment based on the determined risk profile.

7: The system of claim 6, wherein the multiple sensors are moved to a location having a higher risk of a leak.

8: The system of claim 6, wherein the multiple sensors are moved to a location to provide sufficient density of spatial coverage to enable a more accurate quantification of a trace gas leak once detected.

9: The system of claim 6, further comprising:
one or more rails, wherein the multiple sensors are moved along the one or more rails to a new location.

10: The system of claim 6, further comprising:
one or more aerial vehicles, wherein the multiple sensors are moved to a new location by the one or more aerial vehicles.

11: The system of claim 6, wherein the multiple sensors are moved three-dimensionally in a horizontal plane and a vertical plane to increase coverage and improve an ability to track and understand complex boundary layer meteorological flows of the trace gas.

12: A method comprising:
determining a risk profile for one or more trace gas equipment with a potential to leak trace gas;
moving one or more multiple sensors relative to the one or more trace gas equipment based on the determined risk profile; and
generating trace gas data from the moved one or more multiple sensors.

13: The method of claim 12, wherein the determined risk profile is based on at least one of: a history of equipment leak risk, a time since a last leak, a history of actual leaks, a time since last maintenance, and a time since last repair.

14: The method of claim 12, wherein the trace gas data is generated from an emissions sensor of the one or more multiple sensors.

15: The method of claim 12, further comprising:
generating wind data from a wind sensor of the one or more multiple sensors.

16: The method of claim 14, wherein the generated wind data comprises wind speed and wind direction.

17: A method comprising:
generating a first trace gas data from an emissions sensor of a multiple sensors;
generating a first wind data from a wind sensor of the multiple sensors;
determining a first location corresponding to the generated first trace gas data and first wind data from a position sensor of the multiple sensors;
moving the multiple sensors to a second location based on a determined risk profile;
generating a second trace gas data from the emissions sensor of the multiple sensors;
generating a second wind data from the wind sensor of the multiple sensors; and
determining a second location corresponding to the generated second trace gas data and second wind data from the position sensor of the multiple sensors.

18: The method of claim 17, wherein the first wind data includes the wind speed and the wind direction, and wherein the second wind data includes the wind speed and wind direction.

19: The method of claim 17, wherein a GPS determines the first location and the second location.

20: The method of claim 17, wherein moving the multiple sensors to the second location comprises moving the multiple sensors along one or more rails.
